(19) United States
(12) Patent Application Publication
(10) Pub. No.: US 2022/0237721 A1
(43) Pub. Date: Jul. 28, 2022

(54) NETWORKED INFORMATION TECHNOLOGY DEVICES WITH SERVICE LEVEL AGREEMENTS DETERMINED BY DISTRIBUTED NEGOTIATION

(71) Applicant: Hewlett Packard Enterprise Development LP, Houston, TX (US)

(72) Inventors: Thomas Golway, Plandome, NY (US); Sandeep Panda, Houston, TX (US)

(21) Appl. No.: 17/659,489

(22) Filed: Apr. 17, 2022

Related U.S. Application Data
(63) Continuation of application No. 16/356,386, filed on Mar. 18, 2019.

(51) Int. Cl. G06Q 50/18; G06Q 30/06

(52) U.S. Cl. CPC G06Q 50/188; G06Q 30/0611

(57) ABSTRACT

A non-transitory computer readable medium comprising computer executable instructions stored thereon that, when executed by a processor in a source system, cause the processor to receive a smart contract from a customer in a blockchain, the smart contract having a service criteria and a cost for a service and receive automated bids from a plurality of providers, the plurality of providers having access to the blockchain. Additionally, the instructions, when executed by the processor in the source system, further cause the processor to negotiate the smart contract between the customer and a provider based on the ability of the provider to perform the service according to the service criteria and the cost, execute the smart contract for the service between the customer and the provider that matches the service criteria at a lowest cost, and record the smart contract and the negotiations between the customer and the provider.

### CROSS-REFERENCE TO RELATED APPLICATIONS

The present application is a Continuation of, and claims the priority benefit of, U.S. patent application Ser. No. 16/356,386 filed on 18 Mar. 2019. The disclosure of the above-referenced application is incorporated herein by reference in their entirety for all purposes.

### BACKGROUND

Enterprises use hardware and software to deploy and manage resources in a computing environment. As such, enterprises have processes, tools, and automation that manages governance of applications that are deployed within their datacenters. For off-premise deployed applications, enterprises may rely on general contracts with metrics that define service level objectives and service level agreements. The service level objects and service level agreements may be periodically renegotiated, thereby allowing for modification of services, as well as new services, to be provided to the enterprises.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 a schematic representation of an example computing device for negotiating service agreements using blockchain, according to one or more examples of the disclosure.

FIG. 2 is a flowchart depicting a method for negotiating service agreements using blockchain, according to one or more examples of the disclosure.

FIG. 3 is an example computing device with a hardware processor and accessible machine-readable instructions, according to one or more examples of the disclosure.

FIG. 4 a flowchart depicting a method for negotiating service agreements using blockchain, according to one or more examples of the disclosure.

FIG. 5 is an example computing device with a hardware processor and accessible machine-readable instructions, according to one or more examples of the disclosure.

FIG. 6 is a schematic representation of a computer processing device that may be used to implement functions and processes, according to one or more examples of the present disclosure, according to one or more examples of the disclosure.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 200%, for example. Moreover, examples herein are intended to be illustrative only and are presented for discussion purposes and not by way of limitation.

During business transactions, customers may request certain services from providers. The services requested may vary according to the type of business that is being transacted. For example, in a supply chain, a customer may request certain services in the form of products, e.g., components, such as those that may be found in a bill of materials. In order to receive the services, the customer may request bids from one or more providers of the services. The customer may then choose a provider and execute a contract for the purchase of the services from the customer. The process of accepting bids, negotiating terms, finalizing terms, and then executing a contract may take a substantial amount of time and resources. For example, such a process may take weeks, months, or even years.

In another example, a customer may use computing resources at higher levels at particular times. For example, a customer may provide users access to applications, but use of the applications by the users may primarily occur during a select time period. This time period may thus constitute a high use time period. In order to provide adequate resources, the customer may retain designated computing resources that are sufficient to handle the high use time periods, but the computing resources may go unused for time periods outside of the high use time periods. As such, the customer may have expensive and maintenance intensive infrastructure to provide resources during a relatively short period of time.

In order to remove the infrastructure that is only used in short periods of time, a customer may choose to contract out the provisioning of resources during a high use time period. As such, the customer may choose to employ a hybrid information technology model, in which the customer provides the resources during normal operating times, while a provider may provide additional resources during high use times, or as otherwise desired by the customer. By managing resources using a hybrid information technology model, system resources may be used more effectively and provide increased agility for enterprise grade applications.

While such hybrid information technology models provide increased agility, the ability to minimize risk associated with regulations, business model outcomes, and the like may be more difficult. Enterprises may have mature processes, tools, and automation to mange governance of applications deployed within their own data centers. However, for off-premise deployed applications, enterprises rely on general contracts with metrics that are defined by service level objects (“SLOs”) and service level agreements (“SLAs”). SLOs may include elements of SLAs that define a measurable characteristic of the SLA. For example, in the computing resources example above, an SLO may include metrics such as availability, throughput, frequency, response time, quality, and the like. The SLOs in combination may thereby define the expected services to be provided to a user. SLOs may also be composed of one or more quality of service measurements that are used to define a quantitative SLO achievement value.

SLAs may refer to the commitment between a provider and a customer and may be used to address particular aspects of the services provided. SLAs may be used to form a legally binding contract between a customer and a provider, and in addition to defining the aspects of service to be provided, may provide penalties, e.g., remedies, if the services provided do not meet the levels required by the SLAs.

Because of the legal implications that SLAs may impose, the process of negotiating SLAs may be time consuming and expensive. In certain circumstances, the time and cost of negotiating SLAs may outweigh the benefits of implementing a particular service. For example, in the supply chain example above, the change of a component for a device in the supply chain may be desirable, but the cost to negotiate the agreement may cost more than the change may save. As such, a customer may choose not to implement the change in the supply change. Additionally, the time associated with negotiating the agreements may be so long that the benefit of making the change may not be realized. In still other examples, customers and providers may decide to move forward without a formal agreement, thereby making a determination of liability in the case of breach of the agreement more challenging.

Similarly, in the hybrid information technology model discussed above, a customer of resources for running applications may want to have a provider offer the application during high use times or only on an as needed basis. Negotiation of the SLAs may be more expensive than using and/or buying additional infrastructure, even though the infrastructure may be used infrequently. As such, the customer may decide not to employ a more efficient system due to the costs of contract negotiation.

To overcome the issues with SLOs and SLAs, some customers and providers enter into long term deals, thereby making the costs associated with forming the deals amortizable over a relatively long period of time. However, such solutions prevent the customers from adapting to changes in the business environment. For example, if the high use time changes, the customer may be locked into an agreement that no longer provides the services as desired.

Systems and methods provided by the present disclosure may provide relatively fast and inexpensive negotiations of agreements between customers and providers. A customer in a blockchain may provide a smart contract for a service. A number of providers may then submit bids to provide the service. A negotiation may thereby allow the provider that matches the service requested in the smart contract to be selected. The smart contract between the customer and provider may then be executed, and because the smart contract is in blockchain, the executed smart contract may be stored, including data representing the negotiation between the provider and the customer. As such, a master smart contract and all information about the negotiation may be available should a dispute later arise. Additionally, the SLOs and/or SLAs defined in the smart contract may be renegotiated as business requirements of the customer change.

For example, rather than execute long term SLAs, a short-term smart contract may be executed that may then be renegotiated more frequently, but without incurring time consuming and expensive legal costs. In one example, rather than lock into a multiyear contract that has infrequent governance reviews, a customer may enter into a daily, weekly, or monthly contract, that is renegotiated when the contract expires.

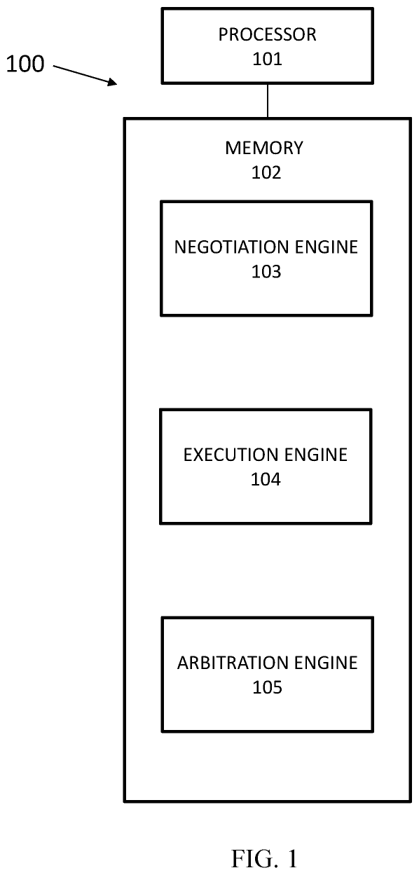

Turning to FIG. 1, a schematic representation of an example computing device for negotiating service agreements using blockchain according to one or more examples is shown. The computing device 100 may use software, hardware, firmware, or logic to perform functions described herein.

Computing device 100 may include hardware and/or programming instructions configured to share information. The hardware, for example, may include one or more processors 101 (one shown) and memory 102, e.g., computer-readable medium (“CRM”), machine readable medium (“MRM”), database, etc. Processor(s) 101 may include any set of processors capable of executing instructions stored by a memory 102. Processor(s) 101 may be implemented in a single device or distributed across multiple devices. The program instructions, e.g., computer readable instructions (“CRI”) may include instructions stored on the memory 102 and executable by the processor(s) 101 to implement a desired function.

Memory 102 may be in communication with processor 101. Memory 102 may include any set of memory components capable of storing instructions that may be executed by processor 101. Memory 102 may be a non-transitory CRM or MRM. Memory 102 may also be integrated in a single device or distributed across multiple devices. Further, memory 102 may be fully or partially integrated in the same apparatus as processor 101 or it may be separate but accessible to that processor 101. Computing device 100 may be implemented on a participant device, on a server device, on a collection of server devices, or a combination of the participant device and the server device.

A set of engines, e.g., a negotiation engine 103, an execution engine 104, and an arbitration engine 105, may include CRI that when executed by the processor 101 can perform functions. The set of engines may be sub-sets of other engines. For example, execution engine 104 may be a sub-set of negotiation engine 103. In another example, the set of engines may include individual engines at separate and distinct locations, e.g., CRM, etc.

The set of engines, i.e., negotiation engine 103, execution engine 104, and arbitration engine 105 may include a combination of hardware and programming that are configured to perform specific functions. Examples of functions that the set of engines may perform include receiving smart contracts from a customer and allowing for negotiating of the smart contract between the customer and one or more providers. Other functions may include executing the smart contract between the customer and a provider selected as meeting the minimum requirements of the smart contract at the lowest cost. Additional functions may include providing an arbitrator that stores a record of the executed smart contract and the negotiation in blockchain. Each engine will be discussed in detail below.

Computing device 100 may include a negotiation engine 103, which may include hardware and/or programming. Negotiation engine 103 may automatically compare information from customers and providers and determine which provider a customer may retain a service from. As used herein, service refers to anything that may be provided by a provider to a customer. For example, a service may refer to a resource on which a customer's applications may reside, while in another example, a service may refer to components of a device, such as a processor, a memory, and the like.

To begin negotiation on negotiation engine 103, a user may submit a smart contract for a service. The smart contract may include a service criteria. The service criteria may include specified variables such as, for example, SLOs, SLAs, demand volume, time periods, component variables, etc. The specific service criteria may depend on the type of service requested. For example, in the hybrid information technology example above, the service criteria may include one or more SLOs, SLAs, and the like that define specific requirements for providing an application from a cloud-based server. Examples of service criteria may include performance, availability, latency, and cost. Other service criteria may also be used depending on the specific requirements of the resources requested.

The smart contract may further include a cost, such as a maximum price the customer is willing to pay for the service. As an example, the customer may submit a smart contract to negotiation engine 103 that indicates that the customer would like to purchase a service having 90 percent availability at a latency of 10 milliseconds (“ms”) or less from a specific location, at a cost not to exceed 10 dollars per unit. In another example, such as in a supply chain, a customer may submit a smart contract to negotiation engine 103 that indicates that the customer would like to purchase a processor of a particular brand, have a processing speed in a range between 1.3 gigahertz (“GHz”) and 1.6 (“GHz”), at a cost not to exceed 20 dollars per unit. The service criteria in either example is therefore defined for each smart contract, and providers the specific criteria they must meet in order to have a chance to receive the contract. In certain examples, the cost may be hidden from the providers, thereby preventing certain providers from lowballing other providers while also increasing the likelihood that a lower cost may be achieved.

Smart contracts may refer to computer implemented computation that occurs on blockchains or a distributed ledger. In the case of blockchain smart contracts, the smart contract may be viewable by all users of the blockchain. Additionally, the terms of the smart contract may become binding upon execution of the smart contract, which will be discussed in detail below. The blockchain structure may also be used to verify the identification of each of the contracting parties and to assure accountability of each party, thereby establishing an ecosystem of trust.

After receiving the smart contract from the customer, a number of providers may provide bids for the smart contract. The bids may include options for services to be provided to the customer that fall within the service criteria. Furthermore, the providers of the service may have a class of service associated therewith.

The class of service may be based on a standard definition of functional, technical, and governance parameters for services to enable automated pricing strategies by class of service through smart contracts. Class of service, in examples such as the hybrid information technology example above may include criteria, such as bandwidth, latency, business requirements, regulatory, compliance, risk, etc., for providing the service. Class of service in other implementations, such as the supply chain implementation may refer to device attributes, functionality, time periods, availability, regulations, compliance, risk, etc. Class of service as used herein may thus refer to is a set of technical attributes, business dependencies, and governance models to support the use case business outcome.

In certain implementations, negotiation engine 103 may have a set of bids that have been previously provided for a particular service. In other implementations, specific providers may bid directly on particular received smart contracts.

Negotiation engine 103 may further determine a set of providers that provide the class of service meeting the service criteria. In such an implementation, negotiation engine 103 may determine that certain service providers do not meet all the specifications in the service criteria, and thus are not qualified to provide the service. In still other implementations, negotiation engine 103 may allow service providers to update or otherwise submit additional bids in response to not receiving a smart contract due to the class of services provided by the provider not meeting the specified service criteria. As such, negotiation engine 103 may facilitate the negotiation of terms of the smart contract between the customer and the provider. In certain implementations, such negotiation may be substantially automated, thereby not requiring user interference. In other implementations, users may update certain aspects of the smart contract and/or the bids.

Because the smart contract occurs using blockchain, as negotiation engine 103 facilitates negotiation of the smart contract, the negotiated terms may be recorded, as they are provided. Accordingly, a history of the negotiation of the smart contract may be captured, thereby providing both parties notice as to how the smart contract was formed.

Using the example of the hybrid information technology example above, a provider may submit a bid based on the received smart contract. The provider may have a class of service that identifies, for example, specific technical attributes, business dependencies, and/or governmental models. In certain implementations, more than one provider may have a class of service into which the service criteria fall. The customer may then select the provider based on one or more of the level of service provided by the provider and/or the lowest cost provider. For example, in certain implementations, multiple providers may submit bids that meet the minimum service criteria. In such a circumstance, negotiation engine 103 may select the bid that has the lowest relative cost. In other circumstances, the cost to service level ratio may result in a bid being selected that is not the lowest but provides a higher level of service.

In the case of the supply chain example, a similar scenario may occur. For example, multiple providers may submit bids that meet the service criteria, but one bid may be higher. In this case, negotiation engine 103 may automatically select the lowest bid. In another implementation, negotiation engine 103 may have instructions to accept a higher bid over a lower bid if the ratio of services provided to cost is within a particular range. In still other implementations, the process of receiving the bids and selecting a provider may be automated by negotiation engine 103, while in other implementations a user from either the provider or customer may provide additional instructions to negotiation engine 103. In the case of an automated process, negotiation engine 103 may automatically select a provider based on the provider meeting the service criteria and having the lowest price.

After a provider is selected, negotiation engine 103 may provide the selected provider and the smart contract to execution engine 104. Execution engine 104 may include hardware and/or programming and may be a separate engine or may be an integral aspect of negotiation engine 103. As such, when the provider is selected, the smart contract may be executed without additional external interference. Execution engine 104 may thereby execute the smart contract between the customer and the provider in the blockchain. Because the smart contract is executed in the blockchain, the record of the negotiation and the terms of the contract may be maintained, thereby allowing each party to know the agreed upon terms.

The smart contract may then be provided to an arbitration engine 105. The arbitration engine 105 may include hardware and/or programming and may be within the blockchain in order to notarize the contract. Notarizing the contract thereby allows a master contract to be maintained so that should a breach of the contract occur, both parties know the final agreed upon terms of the contract. Accordingly, remediation or penalties that are defined in the smart contract may be available, which may later be used in litigation to enforce the contract, assign damages, assign fines, etc. The notarized master contract may be stored in arbitration engine 105, with a third party, or in a device operatively connected thereto.

In addition to the master contract, arbitration engine 105, as it is in the blockchain, has access to the negotiation that occurred between the customer and the provider. As such, any information, contract revisions, offers, rejections, and the like, may be stored as data within the blockchain. Thus, a record of the transaction that lead to execution of the smart contract may be maintained. The record of the transaction may be used in enforcement of the smart contract and may thereby decrease disputes related to whether one or more parties to the smart contract committed a breach of the contract.

In the hybrid information technology example, the smart contract may be executed between the customer and the provider with the lowest cost. After execution, the provider may implement the provisioning of resources as specified in the smart contract. Similarly, in the supply chain example, after execution of the smart contract, the provider may begin processing an order as defined in the smart contract.

In either circumstance, the negotiation of a smart contract may occur that allows a customer and a provider to agree on one or more service criteria. As such, rather than rely on a long processing time for negotiating SLAs, the smart contract may be executed on an as needed basis without external interference. In the case of the supply chain example, SLAs may be provided when no such agreements were in place previously. Due to the rapid deployment of products and services, prior to the negotiation of SLAs disclosed herein, customers and providers went without contracts, thereby not providing a clear understanding of all terms agreed upon. Without negotiated SLAs bound in terms of a smart contract, parties may thereby result to litigating portions of the contract in order to determine which party was at fault. As the smart contract occurs in blockchain, thereby providing a record of each aspect of the transaction, such litigation and costs may be avoided, as the party in breach may be more readily identified.

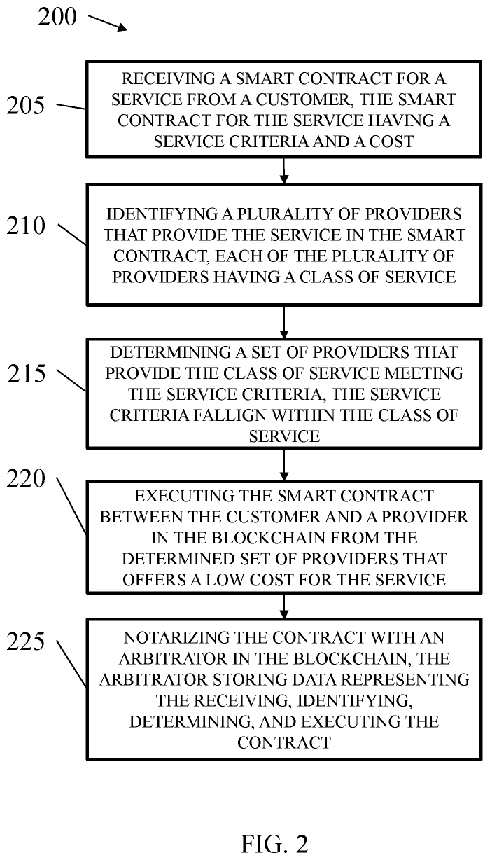

Referring to FIG. 2, a flowchart depicting a method 200 for negotiating service agreements using blockchain according to one or more examples is shown. In operation, method 200 may include receiving (block 205) a smart contract for a service from a customer in a blockchain, the smart contract for the service having a service criteria and a cost. As explained above, the service may include typical services, as well as refer to specific devices, components of devices, and the like. The service criteria may refer to any number of variables that may be defined with respect to particular class of services. For example, service criteria for provisioning of resources for applications may include performance, availability, latency, price, etc. The service criteria may further include other specific technical attributes, business dependencies, and/or governmental models. The business dependencies may be based on specific objectives of the business, timing, etc., while governmental aspects may refer to regulations in the location where the service is provided, hosted, or the like.

The cost may refer to a maximum price a customer is willing to pay for a particular service. The cost may be hidden from any party except the customer until execution of the contract. In certain implementations, the cost may refer to a specific value, while in other implementations, the cost may refer to a range of values.

In operation, method 200 may further include identifying (block 210) a plurality of providers that provide the service in the smart contract, each of the plurality of providers having a class of service. The providers may be identified from a set of providers that have previously submitted bids or may be identified in response to the smart contract being accessible by the providers. The providers may submit bids that offer services that meet the service criteria or may submit bids that offer services similar to the service criteria in order to negotiate the terms of the smart contract.

The class of service may refer to providers that offer services that include one or more service criteria. As such, the class of service may refer to a set of technical attributes, business dependencies, and governance models to support the use case business outcome. Providers that do not have a class of service related to the smart contract may thus not be identified or otherwise not considered during negotiation of the smart contract.

In operation, method 200 may further include determining (block 215) a set of providers that provide the class of service meeting the service criteria, the service criteria falling within the class of service. A number of providers may submit bids for the smart contract. Some of the providers may not meet the service criteria as specified in the smart contract. Such providers may be excluded from negotiation because the services offered do not meet the minimums defined by the service criteria. Other providers may be excluded from consideration because the cost of the offered services is higher than a maximum defined cost in the smart contract.

In operation, method 200 may further include executing (block 220) the smart contract between the customer and a provider in the blockchain from the determined set of providers that offers a low cost for the service. After the bids of the providers are reviewed, a lowest cost that matches the service criteria may be accepted, thereby resulting in an executed smart contract between the customer and the low cost service provider. All terms of the smart contract may thereby be formed within an agreement that is accessible to both parties. In operation, the executing the smart contract may include setting forth the service criteria and the SLAs and/or SLOs that are defined within the smart contract. The smart contract may thereby take the place of SLAs.

In operation, method 200 may further include notarizing (block 225) the smart contract with an arbitrator in the blockchain, the arbitrator storing data representing the receiving, identifying, determining, and executing the contract. The arbitrator may be a third party, separate from both the customer and the provider. Notarization may refer to formally accepting the executed smart contract, and may include governmental notarization, third party notarization, electronic certification, and the like.

As the arbitrator is in the blockchain with the customer and the provider, the arbitrator may have access to not only the executed smart contract, but also the negotiations that occurred between the customer and the provider. This stored data may be accessible for viewing by both the customer and the provider, thereby providing a substantially complete record of each step of the negotiation and execution of the contract. In certain implementations, after execution of the smart contact, the provider may execute the service defined in the smart contract for the customer.

In certain implementations, method 200 may further include adjusting dynamically the service criteria in the request and repeating the identifying, determining, executing, and notarizing in response to the adjusting dynamically the service criteria in the request. In some examples, a customer may request a change to a smart contract in response to a change in a desired technical attribute, business dependency, governmental regulation, or the business environment. Because the negotiation process is relatively quick, rather than wait to adjust the smart contract, the customer may accept new bids with a different service criteria. For example, a customer may determine that greater availability for an application is desirable. The customer may adjust the service criteria in the smart contract and execute a new contract if a provider is able to provide the services at the indicated cost. Dynamically may thus refer to the ability of the customer to change the smart contract in response to a change that affects the services.

In certain implementations, method 200 may also include performing the identifying, determining, executing, and notarizing automatically. In such an implementation, user input may not be required by the customer after the smart contract is received. In other implementations, one or more providers may manually submit bids, however, the identifying, determining, executing, and notarizing may occur in response to the bid submission, requiring no additional user input from the providers. In still other implementations, negotiations may occur between the provider, thereby allowing the provider to update and modify their bid either independently or in response to a rejection based on the provisions of the smart contract.

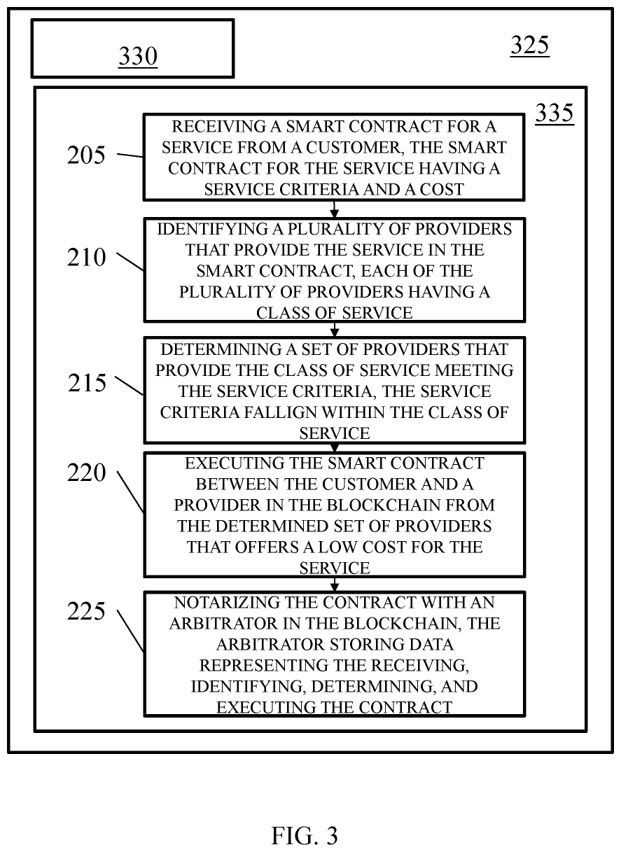

Referring to FIG. 3, an example computing device with a hardware processor and accessible machine-readable instructions, according to one or more examples is shown. FIG. 3 provides an example computing device 325, with a hardware processor 330, and accessible machine-readable instructions stored on a machine-readable medium 335 for generating information about a product as discussed above with respect to one or more disclosed example implementations. FIG. 3 illustrates computing device 325 configured to perform the flow described in blocks 205, 210, 215, 220, and 225, discussed in detail with respect to FIG. 2. However, computing device 325 may also be configured to perform the flow of other methods, techniques, functions, or processes described in this disclosure.

A machine-readable storage medium, such as 335 of FIG. 3, may include both volatile and nonvolatile, removable and non-removable media, and may be any electronic, magnetic, optical, or other physical storage device that contains or stores executable instructions, data structures, program module, or other data accessible to a processor, for example firmware, erasable programmable read-only memory (“EPROM”), random access memory (“RAM”), non-volatile random access memory (“NVRAM”), optical disk, solid state drive (“SSD”), flash memory chips, and the like. The machine-readable storage medium may be a non-transitory storage medium, where the term “non-transitory” does not encompass transitory propagating signals.

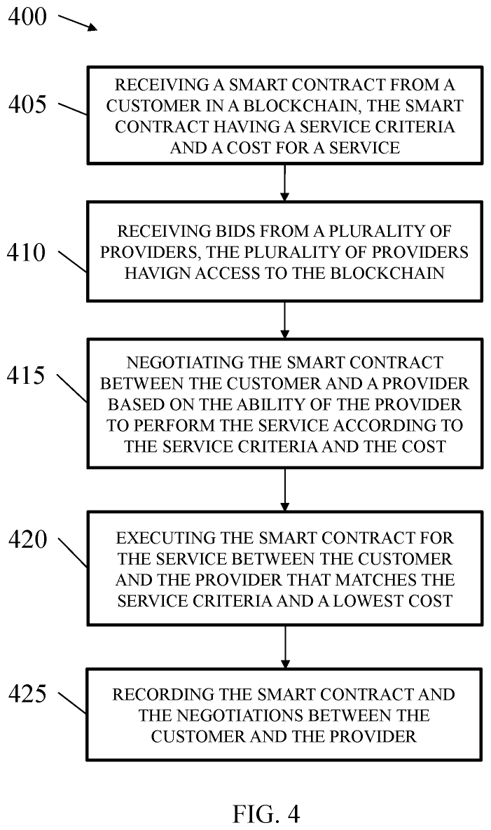

Referring to FIG. 4, a flowchart depicting a method for negotiating service agreements using blockchain according to one or more examples is shown. In operation, method 400 may include receiving (block 405) a smart contract from a customer in a blockchain, the smart contract having a service criteria and a cost for a service. As explained above, the service criteria may be specific to the type of service being requested and may include requirements that may otherwise be found in SLOs and/or SLAs, such as technical attributes, business dependencies, and governmental considerations. The cost may refer to a maximum cost for the service and may be represented as a total cost or a cost per unit basis.

In operation, method 400 may include receiving (block 410) bids from a plurality of providers, the plurality of providers having access to the blockchain. The bids may include a cost for providing the services as defined by the service criteria in the smart contract. The specific response to the service criteria may include an absolute value, a maximum value, or an offering within a range of values. As the providers submit bids as part of the blockchain, a record of all submitted bids may be recorded, as well as any modifications to bids that may occur during the process.

In operation, method 400 may include negotiating (block 415) the smart contract between the customer and a provider based on the ability of the provider to perform the service according to the service criteria and the cost. In certain implementations, the negotiating may include a provider revising a bid in response to a rejection by the customer. For example, if a bid is rejected, a provider may revise the bid to offer a different service criteria or a different cost. In other implementations, the negotiating may include revising the smart contract in response to the submitted bids. For example, if no bids are received for the requested services, the customer may decrease the cost or otherwise modify the service criteria in order to receive bids from providers.

In other implementations, negotiating may refer to reviewing the bid from one or more providers and making a determination of which bid to accept. The determination may be based on the cost and/or how the services match the service criteria. In automated implementations, the bid may be accepted that meets the minimum requirements of the service criteria as defined in the smart contract and has the lowest cost. Such automated implementations may thereby allow for the negotiations of smart contracts without user intervention.

Method 400 may include executing (block 420) the smart contract between the customer and a provider based on the ability of the provider to perform the service according to the service criteria and the cost. As previously explained, executing the smart contract may formalize the agreement between the parties, thereby allowing SLOs and SLAs to be included as service criteria that are formalized within the smart contract without requiring the time and expense normally associated with the negotiation and execution of such agreements. The executing the smart contract may be substantially automated as the smart contract may give permission for acceptance of a bid as long as the bid meets the minimum service criteria and is under the maximum cost. The executing the smart contract may also be substantially automated, as submission of a bid by a provider may indicate that if the bid is accepted, the bid will be formally executed as a smart contract. Accordingly, after submission of the bid, no additional input may be required by either the customer or user in executing the smart contract.

In operation, method 400 may further include recording (block 425) the smart contract and the negotiations between the customer and the provider. As the negotiation occurs through a blockchain-based smart contract, all submissions by the customer and the providers may be maintained in an immutable form. Similarly, the smart contract, upon execution, may also be recorded in an immutable form. Each step in the receiving the smart contract and bids, as well as negotiating the smart contact and executing the smart contact may thus be preserved. The executed smart contract and data associated therewith may be preserved as a master contract that is stored by a third party but is accessible for viewing by either the customer or the provider.

In certain implementations, the negotiating, executing, and recording may occur in real-time. For purposes of this disclosure real-time may refer to aspects that occur substantially in real-time. For example, the negotiating may result in a provider that is selected. Real-time implementation refers to the execution and recording occurring without further external interference. Thus, after the provider is selected, the smart contract may be executed and recorded, and no additional information may be provided to complete the process. Real-time implementation may thereby reduce the amount of time and resources required for the negotiation and execution of other agreements, such as SLAs, as discussed above. As the negotiation and execution of SLAs may take months and cost substantially amounts of money, the methods provided herein may provide a real-time option for negotiating and executing smart contracts that is relatively fast and inexpensive.

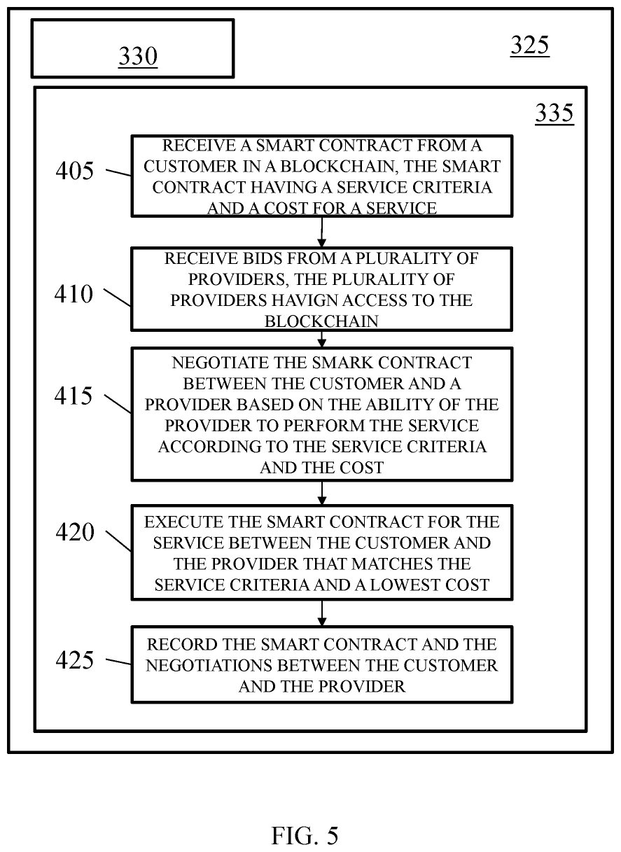

Referring to FIG. 5, an example computing device with a hardware processor and accessible machine-readable instructions, according to one or more examples is shown. FIG. 5 provides similar structural components discussed above with respect to FIG. 3, and as such, for purposes of clarity, only the differences in the figures will be discussed herein. FIG. 5 provides an example computing device 325, with a hardware processor 330, and accessible machine-readable instructions stored on a machine-readable medium 335 for managing data as discussed above with respect to one or more disclosed example implementations. FIG. 5 illustrates computing device 325 configured to perform the flow described in blocks 405, 410, 415, 40, and 4205, discussed in detail with respect to FIG. 4.

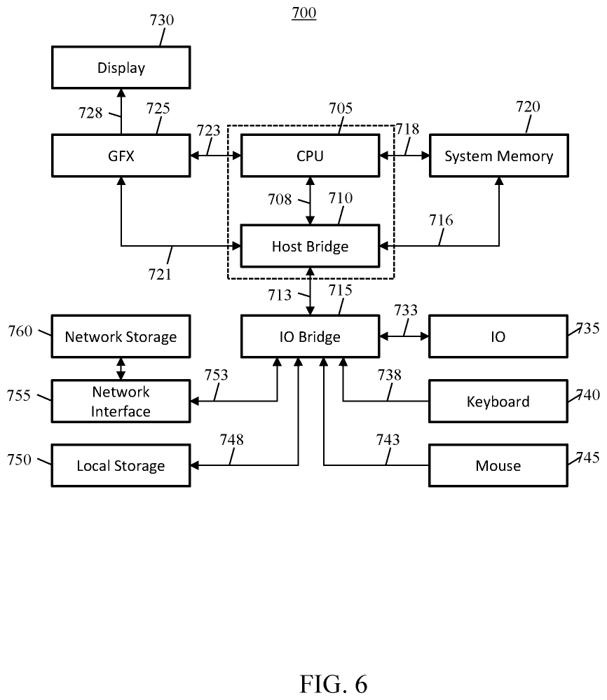

Turning now to FIG. 6, a schematic representation of a computer processing device 700 that may be used to implement functions and processes in accordance with one or more examples of the present disclosure is shown. FIG. 6 illustrates a computer processing device 700 that may be used to implement the systems, methods, and processes of this disclosure. For example, computing device 700 illustrated in FIG. 6 could represent a client device or a physical server device and include either hardware or virtual processor(s) depending on the level of abstraction of the computing device. In some instances (without abstraction), computing device 700 and its elements, as shown in FIG. 6, each relate to physical hardware. Alternatively, in some instances one, more, or all of the elements could be implemented using emulators or virtual machines as levels of abstraction. In any case, no matter how many levels of abstraction away from the physical hardware, computing device 700 at its lowest level may be implemented on physical hardware. In one implementation, computing device 700 may allow a subscriber to remotely access one or more data centers. Similarly, the management tool used by the subscriber may include a software solution that runs on such a computing device 700.

FIG. 6 shows a computing system 700 in accordance with one or more examples of the present disclosure. Computing system 700 may be used to implement aspects of the present disclosure, such as an orchestrator, a gateway manager, a cloud monitor, a local storage, a cloud-based storage, or any other device that may be used implementing the systems and methods for managing data discussed herein. Computing system 700 may include one or more central processing units (singular “CPU” or plural “CPUs”) 705 disposed on one or more printed circuit boards (not otherwise shown). Each of the one or more CPUs 705 may be a single-core processor (not independently illustrated) or a multi-core processor (not independently illustrated). Multi-core processors typically include a plurality of processor cores (not shown) disposed on the same physical die (not shown) or a plurality of processor cores (not shown) disposed on multiple die (not shown) that are collectively disposed within the same mechanical package (not shown). Computing system 700 may include one or more core logic devices such as, for example, host bridge 710 and input/output (“10”) bridge 715.

CPU 705 may include an interface 708 to host bridge 710, an interface 718 to system memory 720, and an interface 723 to one or more 10 devices, such as, for example, graphics processing unit (“GFX”) 725. GFX 725 may include one or more graphics processor cores (not independently shown) and an interface 728 to display 730. In certain examples, CPU 705 may integrate the functionality of GFX 725 and interface directly (not shown) with display 730. Host bridge 710 may include an interface 708 to CPU 705, an interface 713 to 10 bridge 715, for examples where CPU 705 does not include interface 718 to system memory 720, an interface 716 to system memory 720, and for examples where CPU 705 does not include integrated GFX 725 or interface 723 to GFX 725, an interface 721 to GFX 725. One of ordinary skill in the art will recognize that CPU 705 and host bridge 710 may be integrated, in whole or in part, to reduce chip count, motherboard footprint, thermal design power, and power consumption. IO bridge 715 may include an interface 713 to host bridge 710, one or more interfaces 733 to one or more IO expansion devices 735, an interface 738 to keyboard 740, an interface 743 to mouse 745, an interface 748 to one or more local storage devices 750, and an interface 753 to one or more network interface devices 755.

Each local storage device 750 may be a solid-state memory device, a solid-state memory device array, a hard disk drive, a hard disk drive array, or any other non-transitory computer readable medium. Each network interface device 755 may provide one or more network interfaces including, for example, Ethernet, Fibre Channel, WiMAX, Wi-Fi®, Bluetooth®, or any other network protocol suitable to facilitate networked communications. Computing system 700 may include one or more network-attached storage devices 760 in addition to, or instead of, one or more local storage devices 750. Network-attached storage device 760 may be a solid-state memory device, a solid-state memory device array, a hard disk drive, a hard disk drive array, or any other non-transitory computer readable medium. Network-attached storage device 760 may or may not be collocated with computing system 700 and may be accessible to computing system 700 via one or more network interfaces provided by one or more network interface devices 755.

One of ordinary skill in the art will recognize that computing system 700 may include one or more application specific integrated circuits (“ASICs”) that are configured to perform a certain function, such as, for example, hashing (not shown), in a more efficient manner. The one or more ASICs may interface directly with an interface of CPU 705, host bridge 760, or IO bridge 715. Alternatively, an application-specific computing system (not shown), sometimes referred to as mining systems, may be reduced to only those components necessary to perform the desired function, such as hashing via one or more hashing ASICs, to reduce chip count, motherboard footprint, thermal design power, and power consumption. As such, one of ordinary skill in the art will recognize that the one or more CPUs 705, host bridge 710, IO bridge 715, or ASICs or various sub-sets, super-sets, or combinations of functions or features thereof, may be integrated, in whole or in part, or distributed among various devices in a way that may vary based on an application, design, or form factor in accordance with one or more example examples. As such, the description of computing system 700 is merely an example and not intended to limit the type, kind, or configuration of components that constitute a computing system suitable for performing computing operations, including, but not limited to, hashing functions. Additionally, one of ordinary skill in the art will recognize that computing system 700, an application specific computing system (not shown), or combination thereof, may be disposed in a standalone, desktop, server, or rack mountable form factor.

One of ordinary skill in the art will recognize that computing system 700 may be a cloud-based server, a server, a workstation, a desktop, a laptop, a netbook, a tablet, a smartphone, a mobile device, and/or any other type of computing system in accordance with one or more example examples.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A method for negotiating service agreements, the method comprising:
receiving a request for a service from a customer, the request for the service having a service criteria and a cost;
identifying a plurality of providers that provide the service in the request for service, each of the plurality of providers providing services in a class of service;
determining a set of providers that provide the class of service meeting the service criteria, the service criteria falling within the class of service;
executing a contract between the customer and a provider from the determined set of providers that offers a low cost for the service; and
notarizing the smart contract with an arbitrator, the arbitrator storing data representing the receiving, identifying, determining, and executing the contract.

2. The method of claim 1, wherein the smart contract comprises a service level agreement, the service level agreement defining the service provided by the provider to the customer.

3. The method of claim 2, wherein the service level agreement comprises at least one service level objective.

4. The method of claim 1, wherein the low cost is less than the cost.

5. The method of claim 1, further comprising executing the service for the customer by the provider.

6. The method of claim 1, wherein the class of service comprises a business dependency and a technical attribute.

7. The method of claim 1, further comprising adjusting dynamically the service criteria in the request and repeating the identifying, determining, executing, and notarizing in response to the adjusting dynamically the service criteria in the request.

8. The method of claim 1, further comprising performing the identifying, determining, executing, and notarizing automatically.

9. A non-transitory computer readable medium comprising computer executable instructions stored thereon that, when executed by a processor in a source system, cause the processor to:
receive a smart contract from a customer in a blockchain, the smart contract having a service criteria and a cost for a service;
receive automated bids from a plurality of providers, the plurality of providers having access to the blockchain;
negotiate the smart contract between the customer and a provider based on the ability of the provider to perform the service according to the service criteria and the cost;
execute the smart contract for the service between the customer and the provider that matches the service criteria at a lowest cost; and
record the smart contract and the negotiations between the customer and the provider.

10. The non-transitory machine-readable storage medium of claim 9, further comprising instructions that when executed by the processor cause the processor to arbitrate the smart contract when a breach of the smart contract is identified.

11. The non-transitory machine-readable storage medium of claim 9, wherein the cost is hidden from the plurality of providers.

12. The non-transitory machine-readable storage medium of claim 9, wherein the service criteria comprises at least one of a service level objective and a service level agreement.

13. The non-transitory machine-readable storage medium of claim 9, further comprising instructions that when executed by the processor cause the processor to negotiate, execute, and record in real-time.

14. The non-transitory machine-readable storage medium of claim 9, wherein the instructions to negotiate, execute, and record occurs automatically.

15. A system for negotiating service criteria, the system comprising:
a computing device having a processor and a memory;
a negotiation engine stored in the memory, the negotiation engine to receive a smart contract from a customer in a blockchain, the smart contract having a service criteria and a cost for a service, to receive bids from a plurality of providers of the service in the smart contract, and to determine which provider will provide the service to the customer;
an execution engine stored in the memory, the execution engine to execute the smart contract between the customer and the provider in the blockchain that was determined to provide the service to the customer by the negotiation engine; and
an arbitration engine stored in the memory, the arbitration engine to record the smart contract between the customer and the provider.

16. The system of claim 15, wherein the arbitration engine further records a negotiation between the customer and the provider.

17. The system of claim 15, wherein the service criteria comprises at least one of a service level object and a service level agreement.

18. The system of claim 15, wherein the arbitration engine further stores the smart contract as a master contract.

19. The system of claim 15, wherein the smart contract comprises penalties, the penalties defining remedies for a breach of the smart contract.

20. The system of claim 15, wherein the negotiation engine determines which provider will provide the service to the customer based on a comparison of the services and a bid cost to the service criteria and the cost.
